(19) United States
(12) Patent Application Publication
(10) Pub. No.: US 2026/0274354 A1
(43) Pub. Date: Sep. 17, 2026

(54) ROBOT, ADAPTED FOR MOVEMENT UNDERNEATH AND IN CONTACT WITH A CEILING

(71) Applicant: Georg-August-Universität Göttingen Stiftung Öffentlichen Rechts, Göttingen (DE)

(72) Inventors: Marcus BAUM, Göttingen (DE); Aaron KURDA, Göttingen (DE)

(73) Assignee: Georg-August-Universität Göttingen Stiftung Öffentlichen Rechts, Göttingen (DE)

(21) Appl. No.: 19/548,802

(22) Filed: Feb. 24, 2026

(30) Foreign Application Priority Data
Mar. 13, 2025 (DE) 10 2025 109 673.2

(51) Int. Cl. B62D 57/024; B64B 1/08

(52) U.S. Cl. CPC B62D 57/024; B64B 1/08

(57) ABSTRACT

The present invention relates to a robot (100), which is adapted for movement underneath and in contact with a ceiling (D), comprising at least one lift body (102), which is filled with gas which is lighter than air, and at least one drive unit (106), which is adapted to drive the at least one lift body (102) in rotation for rolling on the ceiling (D), wherein the at least one drive unit (106) is positioned with respect to the lift body (102) in such a manner that during movement of the robot (100) it remains spaced apart from the ceiling (D).

### CROSS REFERENCE TO RELATED APPLICATION

This application claims priority to German Patent Application No. 10 2025 109 673.2, filed Mar. 13, 2025, the disclosure of which is incorporated herein by reference in its entirety.

### SUMMARY

The present invention relates to a robot, which is adapted for movement underneath and in contact with a ceiling.

There are different use cases conceivable, in which robots can be used in interior spaces and shall in particular not be in contact with the ground. One example which shall not be understood as limiting for the invention would be sensor data taking from above, for example for supervision of a corresponding working area inside a closed space from a bird’s eye view. In general, such robots can be used for arbitrary tasks in spaces, in which they have to be capable of movement underneath the ceiling, wherein in a particularly simple case such robots could for example serve as movable markers for certain positions on ceilings, even if they are not provided with sensors for supervision or sensor data taking. Further use cases in which sensors are not imperative could also be gaming and entertainment applications, for example light or drone shows.

For such purposes, recently small unmanned aerial vehicles have increasingly been used, which are also referred to as drones or UAVs (unmanned aerial vehicles). Herein, environments in interior spaces are particularly challenging for such UAVs, as they often have to navigate in restricted spaces and in the proximity of persons or equipment which leads to an increased risk of collisions and in general restricts the available spaces for movement.

One example for a type of construction of such UAVs are so-called multi-copters, which with a plurality of propellers create lift and which by differential control of said propellers can move in space. However, such multi-copters by permanently creating lift by mechanical means require a large amount of energy and can thus only provide limited continuous flight times. Furthermore, the propellers are relatively noisy and can be a hazard for persons or objects in the surroundings, while they themselves are sensitive concerning damage when colliding with objects, etc. in the respective interior spaces.

In contrast, unmanned airships are considered to be relatively safe and by means of their static lift can provide longer flight times compared to multi-copters. On the other hand they are limited concerning their navigation capabilities and their payload capacities and they also require propellers for propulsion with the resulting drawbacks already discussed.

Both multi-copters and airships are known to be capable of three-dimensional movement, i.e. they cannot only move in a horizontal plane but also in vertical direction. In certain use cases, for example the already discussed supervision of spaces, such a full three-dimensional movability in space is not necessarily required, however. In particular, in such scenarios, the bird’s eye view can be sufficient, i.e. the degree of freedom in vertical direction can be omitted and permanent contact of a corresponding robot with the ceiling can be acceptable.

Thus, for such use cases, ceiling robots are suitable, which use the maximum height of spaces and require dedicated infrastructure in the region of the ceiling. For example, hanging robots (Fukui et al. 2014; Hangbot: A Ceiling Mobile Robot with Robust Locomotion under a Large Payload: Basic Design and Development of Key Mechanisms, Springer Berlin Heidelberg, pp. 685-694) and systems based on magnets (Seriani et al. 2019, „Upside-down robots: Modeling and experimental validation of magnetic-adhesion mobile systems“ Robotics, vol. 8, No.2, p. 41) as well as climbing robots have been proposed in the art, which can climb on walls by means of vacuum technology (Fang et al. 2022, „Design and technical development of wall-climbing robots: A review“ Journal of Bionic Engineering, vol. 19, No.4 pp. 877-901).

Furthermore, it is in principle known to use spherical robots in ground-based operations, wherein an overview over corresponding use cases is given for example in Bujnac et al. 2022, Spherical Robots for Special Purposes: A Review on Current Possibilities, Sensors, 22, 1413. Herein, different established drive mechanics are discussed, which allow for different forms of movement. As already mentioned, all spherical robots described therein are embodied such as to rest on floors or surfaces, which then form a corresponding underground for movement.

Further examples of spherical robots for movement on floors are known from US 8 571 781 B2 and US 2013 0233 630 A1, in each of which by means of a drive device a rotation of the spherical body of the robot is caused and it is driven in such a manner for movement on the ground.

Furthermore, from US9428019B1, an amphibious spherical robot is known, which can precisely move on land as well as in water or snow, while from Williams and Hong 2021; Introduction and preliminary investigation of buoyancy assisted robots that are cheap, safe, and will never fall down; ASME 2021 International Design Engineering Technical Conferences and Computers and Information in Engineering Conference - Vol. 8B: 45th Mechanisms and Robotics Conference (MR), ser. IDETC-CIE2021 American Society of Mechanical Engineers, Aug. 2021 buoyancy assisted robots (BAR) are known which use buoyancy as main means against gravity and which are characterized by being very light and thus have low potential for causing serious accidents. Herein, by means of the ratio between buoyancy and weight it can be controlled whether such a robot moves in vertical direction or whether it is merely an upright robot with ground contact.

One further example for an autonomous small format ceiling robot is found in JP 2005 349 517 A which as corresponding means for travel comprises legs, a chain drive or similar means. For creating lift, in this context propellers, a balloon filled with helium, etc. are proposed. Thus, the gravity acting on the components of the robot is reduced, which in turn facilitates movement on three dimensional surfaces.

On the other hand, examples for “lighter than air” drones are known from US 11 840 358 B2 and CN 206 171 785 U, in each of which a balloon shaped structure is provided which for creating lift is filled with a gas which is lighter than air. For the propulsion of such drones, for example ducted propellers and similar devices can be used.

All of the robots known from the prior art just described are relatively complex and expensive concerning their construction or exhibit other drawbacks, which have already been discussed in detail. It is therefore the object of the present invention to provide a robot that is constructed in a simple and generally efficient manner, which can move below a ceiling in interior spaces and which in this context can perform different tasks.

For achieving this object and in order to overcome the drawbacks of the known prior art as discussed above, according to the present invention it is proposed that such a robot comprises at least one lift body which is filled with a gas which is lighter than air, and at least one drive unit which is configured to drive the at least one lift body in rotation for rolling on the ceiling, wherein the drive unit is positioned with respect to the lift body in such a manner, that during movement of the robot it remains spaced apart from the ceiling.

Thus, in the robot according to the present invention the yet unknown concept is implemented, that it is held on the ceiling by means of the gas contained in the lift body, for example helium, while the lift body can be driven in rotation by the drive unit, which in turn will cause movement of the robot along the ceiling. The lift body in the robot according to the invention therefore has the double function of on the one hand containing and holding the “lighter than air” gas and on the other hand causing propulsion of the robot on the ceiling by rotation caused by the drive unit. The drive unit used may be of an arbitrary type, in particular, different kinds of electric motors may be used which may be controlled precisely and may be operated in an energy efficient manner.

Herein, the robot according to the invention in a most simple conceivable case may be provided with only the drive unit, in order to be able to move along the ceiling, for example if it is merely to serve as a movable marker or in similar use cases. In case it shall perform additional tasks apart from such a movement, however, it can additionally be equipped with further electric and/or electronic components, such as an energy storage unit, a communications unit, a control unit with different capabilities, etc.

In particular, it can be intended that the robot according to the invention further comprises at least one sensor unit, which preferably is arranged on a common carrier unit together with the drive unit already mentioned. The corresponding carrier unit may for example be implemented in the shape of a building panel and may of course additionally carry further of the above-mentioned and different conceivable components, in order to facilitate an increased integration of the design of the robot and a space-efficient construction. Corresponding sensor units could be a camera unit, a radar sensor, temperature sensors, positioning units and various other conceivable sensor types, which can be adapted to the tasks to be performed by the respective robot.

In particular, in an especially simple design the robot according to the present invention may comprise only a single substantially spherical lift body, such that an omnidirectional rotation and corresponding movement along a horizontal ceiling in all directions is made possible in a simple manner. Also with respect to other properties of the robot according to the invention, a spherical lift body may be beneficial, for example it can be held in shape in a simple manner merely by its internal pressure, without further measures necessary for maintaining its shape. It should be understood that such an originally spherical lift body may deform to a certain extend during operation of the corresponding robot, for example it may flatten in the contact region with the ceiling, wherein the extend of the deformation may depend on the flexibility of the material of the lift body and the internal pressure of the contained gas, etc.

Alternatively, it would also be possible that the at least one lift body has a cylindrical shape, by means of which a reduction of the height of the robot could be achieved, if necessary. For example, an embodiment would be possible in which a plurality of cylindrical lift bodies can be provided, which are coupled by means of an external structural element, wherein the structural element may preferably comprise the at least one drive unit. For this purpose, in a particularly simple variation of such an embodiment designs would be possible, in which two cylindrical lift bodies are coupled by means of such an external structural element and by means of a differentially driven rotation of the two cylindrical lift bodies an arbitrary movement of the robot along the ceiling can be achieved.

In a particularly preferred design of a robot according to the present invention, which may specifically be implemented in the above-mentioned embodiment with a spherical lift body, a single lift body may be provided and the drive unit and the sensor unit, if applicable, may fully be housed inside the lift body, preferably in a manner not fixedly connected to the lift body. Thus, the above-mentioned components by means of the effect of gravity would arrange themselves at all times at a vertically lower position inside the lift body and be in contact with the inner side of the lift body, such that at this location, the drive unit could exert a driving force onto the lift body. Even though only the drive unit and the sensor unit have explicitly been mentioned, it should be understood that in such a design, all electric and electronic as well as mechanical components of the robot may be positioned inside the lift body, such that consequently the outer shape of the lift body dictates the overall dimensions of the robot as well. Such a design of a robot according to the present invention has the additional benefit that all further components are hermetically enclosed inside the lift body and are as such not exposed to harmful environmental influences.

Alternatively, a single lift body could be provided, and the drive unit could be arranged outside the lift body and could preferably be held in contact with the lift body by means of magnets arranged inside the lift body. Accordingly, one or more permanent magnets could be housed inside the lift body, which in a similar manner as described above due to the effect of gravity would position themselves in a vertically low part thereof, wherein correspondingly on the outer side of the lift body also by means of a permanent magnet and due to magnetic attraction, the drive unit could be coupled therewith. It shall be understood that the assembly which can be magnetically coupled and which can comprise the drive unit can further comprise any additional components of the robot, for example the sensor unit already mentioned, an energy storage unit, etc.

Further alternatively, embodiments are possible, in which the drive unit and any further components can be attached to the lift unit on its outer side by means of a suitable attachment, such that they are at all times spaced apart from the ceiling, when the robot travels along said ceiling.

It shall further be pointed out that in the robot according to the present invention, the drive unit may be embodied as an omnidirectional drive unit, in particular with two or more drive wheels or a spherical drive element in contact with the lift body. In this manner, an arbitrary movement of the robot along the ceiling can be caused by controlling and driving the corresponding drive units in a suitable manner. In particular, by means of differential drive of at least two drive wheels in contact with the lift body, both a movement along arbitrary directions and a rotation of the robot in place can be achieved, which may for example be beneficial when a camera or a similar sensor unit of the robot has to be oriented without the need of moving the robot.

It shall further be pointed out that the lift body may be made from a transparent and/or deformable material, wherein in particular in cases, in which optical sensor units are arranged inside the lift body, by means of the transparency of the lift body, the capturing of optical images therethrough can be facilitated. The use of deformable material to some extent allows for travelling over uneven regions or small obstacles on the corresponding ceiling, as the outer shape of the lift body can accommodate these to the corresponding extent. Furthermore, by means of deformability of the material, a larger contact area between the lift body and the ceiling can be created, which can result in improved travelling performance of the robot. Additionally, the material of the lift body can for example be chosen such that gas contained therein will leak out as little as possible or stays inside the lift body for as long as possible to such an extent that the operation thereof is possible. For this purpose, any suitable coatings, etc. can be used, wherein additionally, the outer side of the lift body which comes into contact with the ceiling can be treated in such a manner that its friction on the ceiling is increased, in order to minimize slip during travelling.

Furthermore, embodiments are possible, in which the at least one lift body is surrounded by at least one further mantle body, which is of substantially the same shape yet of larger dimensions as the lift body and preferably made from a transparent and/or deformable material. Accordingly, in such embodiments the drive unit may for example be arranged inside the lift body in the manner described above and a sensor unit and further additional components can be housed between the lift body and the further mantle body, in order to combine the advantages of the two variants described above to some extent.

As already mentioned earlier, the robot according to the invention may further comprise an energy storage unit for powering the components of the robot, which preferably can be charged in a contactless manner via induction. By providing the possibility of charging via induction, it is possible to also fully house the energy storage unit inside the lift body such there is no need for direct mechanical contact via an interface for charging, etc. Alternatively, embodiments of the robot according to the invention are possible, in which an energy storage unit for powering the drive unit and other components is omitted and the energy supply is continuously provided via induction, for example by means of induction antennas integrated into the corresponding ceiling.

It is also possible to integrate a jump mechanism into the robot according to the invention, which is adapted to cause a push-off of the at least one lift body from the ceiling. In this manner, obstacles can for example be evaded in that the corresponding robot approaches the obstacle with a certain travelling velocity, the jump mechanism is operated at a suitable moment to cause a push-off from the ceiling and avoiding the obstacle vertically downwards, before the robot comes back into contact with the ceiling due to its lift.

It shall further be pointed out that even though corresponding robots can be remote controlled and for this purpose can comprise a suitable control unit as well as a communications unit, which directly can receive work commands and in particular control commands for the drive unit from a human operator via a remote control, alternatively or additionally corresponding robots may also comprise control units which are configured for operating the robot in an autonomous mode. For this purpose, a suitable sensor arrangement would be necessary, for example a positioning sensor arrangement and/or an image acquisition sensor arrangement with subsequent image processing, in order to be able to perform the corresponding desired tasks of the robot based on the sensor data and suitable data processing programs in an autonomous manner.

### BRIEF DESCRIPTION OF THE DRAWINGS

Further features of the present invention will become even clearer from the following description of embodiments thereof, when taken together with the accompanying drawings, which are all to be understood as purely schematic and in particular not to scale. These drawings show:

FIGS. 1a and 1b illustrate two variants of a first embodiment of a robot according to the present invention;

FIGS. 2a and 2b illustrate two variants of a second embodiment of a robot according to the present invention;

FIG. 3 illustrates a view of a third embodiment of a robot according to the present invention; and

FIG. 4 illustrates a view of a fourth embodiment of a robot according to the present invention, all in sectional views.

### DETAILED DESCRIPTION

The enclosed figures show different variants and embodiments of robots according to the present invention in respective sectional views, which are located underneath a ceiling D. They are kept on the respective ceiling D by the effect of a respective lift body which is filled with gas which is lighter than air, in particular helium. It shall generally be pointed out that the lift bodies of all robots discussed herein may be provided with respective valves in order to allow filling thereof with the respective gas.

The particular embodiments which are in the following described with reference to the figures differ on the one hand in the shape and number of the lift bodies and on the other hand in the arrangement of further functional components of the respective robots, wherein similar or equivalent components of the individual robots are denoted with the same reference numerals, increased by a multiple of 100 and/or provided with an apostrophe.

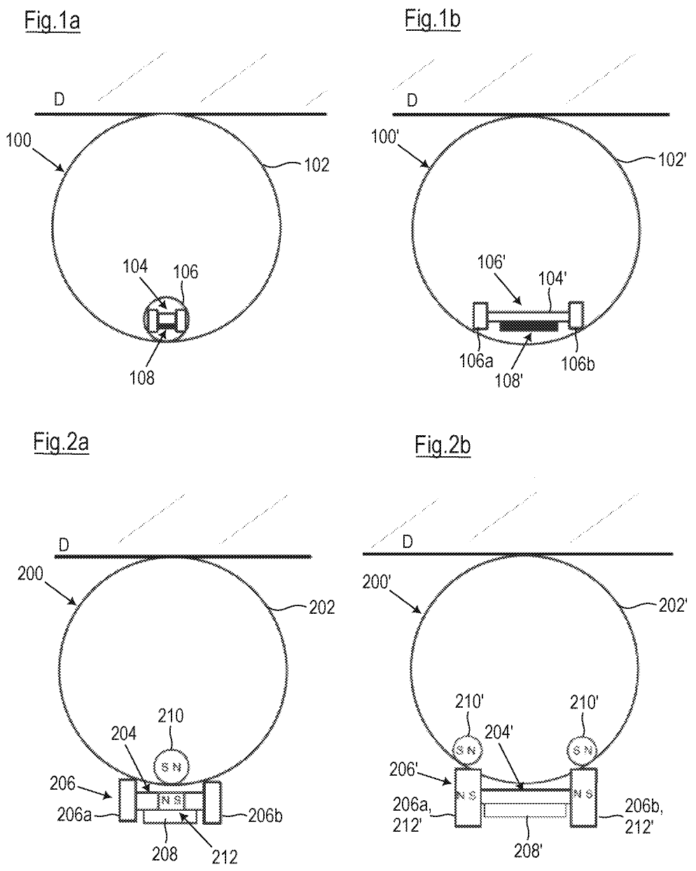

First of all, FIGS. 1a and 1b show two variants 100 and 100’ of robots according to the invention, each of which comprise a single spherical lift body 102 and 102’, respectively. Inside said lift bodies 102, 102’ a mechanical assembly 104, 104’ is housed, which by the effect of gravity is in contact with the lift body 102, 102’ on its inner wall on a lower side.

Herein, the two variants 100 and 100’ of FIGS. 1a and 1b differ in how the respective mechanical assemblies 104, 104’ are designed. Both of said assemblies 104, 104’ comprise a drive unit 106, 106’ which is configured to drive the lift body 102, 102’ in rotation in order to facilitate rolling and thus movement thereof along the ceiling D.

It shall further be pointed out that the assemblies 104, 104’ can each further comprise additional functional components, such as a sensor unit 108, 108’ schematically shown as a rectangle, which may be formed by a camera or a similar element. For this purpose, it is beneficial in the variants of FIGS. 1a and 1b if the respective lift bodies 102, 102’ are made from a transparent material.

Both variants 106, 106’ of the respective drive units are formed as omnidirectional drive units, wherein in the variant of FIG. 1a a single spherical drive unit 106 is used, which in rotation drives the lift body 102 in counterrotation and can thus cause movement of robot 100. In contrast, in the variant of FIG. 1b two drive wheels 106a, 106b are provided as part of the drive unit 106’ which can be driven differentially, in order to also be able to cause omnidirectional movement of the lift body 102’ and thus the robot 100’ along the ceiling D.

Herein, the two variants of FIGS. 1a and 1b are characterized in that all of their electrical, electronic and mechanical components are fully housed inside the lift bodies 102, 102’, such that these components cannot be affected by external influences and thus a safe and reliable operation can be achieved. However, in such embodiments installing and servicing of the respective components is difficult, as the inside of the lift body 102, 102’ has to be accessed by means of a suitable entry, in order to reach the respective components, including the drive units 106, 106’. Furthermore, energy storage units potentially arranged inside the lift body 102, 102’ have to be charged by means of induction as they can also not easily be accessed from the outside, as long as again a corresponding entry is not to be opened.

In contrast, the two variants 200 and 200’ of FIGS. 2a and 2b have the advantage that their drive units 206, 206’ as well as the sensor units 208, 208’ shown as empty rectangles and possible additional components are arranged outside of the lift bodies 202, 202’. In order to nevertheless hold the assemblies 204, 204’ in a suitable position spaced apart from the ceiling D, in particular on a vertically low side of the lift bodies 202, 202’, for this purpose a magnetic coupling is provided, wherein one or more permanent magnets 210, 210’ are housed inside the lift bodies 202, 202’ and will position themselves in a lower part thereof, while the assemblies 204, 204’ are each also provided with one or more permanent magnets 212, 212’, in order to facilitate a corresponding coupling. In the variant of FIG. 2a only a single central pair of magnets is provided, while in the variant of FIG. 2b the wheels 206a, 206b of the drive unit 206 are themselves embodied as permanent magnets and can thus magnetically couple with the permanent magnets 210’ inside the lift body 202 accordingly.

Thus, these two variants of a robot according to the present invention are characterized in that their drive units and further assemblies can easily be accessed which at the same time makes them more susceptible to external influences.

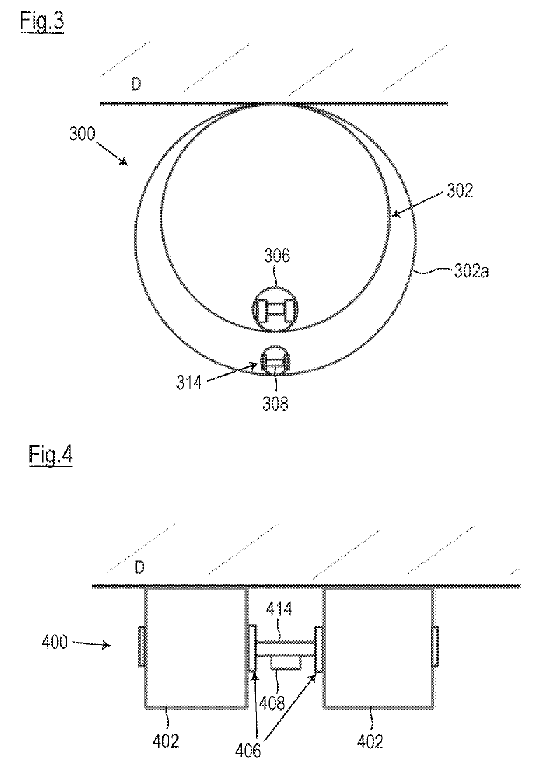

Embodiment 300 of FIG. 3 is in contrast characterized in that in addition to the lift body 302 a further mantle body 302a is provided which surrounds the lift body 302 and has substantially the same spherical shape yet larger dimensions. Herein, the drive unit 306 similarly to the variant 100 of FIG. 1a is embodied by a spherical drive element, which is positioned inside the lift body 302, wherein in a further variant, which is not shown, the wheel arrangement of FIG. 1b could be used as well. Furthermore, an additional assembly 314 is arranged between the lift body 302 and the further mantle body 302a which may for example carry the sensor unit 308. By means of the effect of gravity, the drive unit 306 and the further assembly 314 will again position themselves at a low vertical position inside the lift body 302 and the further mantle body 302a, respectively. This embodiment 300 correspondingly has the advantages of both the embodiments of FIGS. 1a-2b, however due to the additional provision of the further mantle body 302a has a more complex design and requires more components.

Lastly, reference shall be made to the fourth embodiment of FIG. 4, which is characterized by a particularly flat design and is as such particularly suited for spaces in which the available vertical space is limited. This variant 400 comprises two cylindrical lift bodies 402 which are connected by means of an external structural element 414, which carries both the respective drive units 406 for the two lift bodies 402 and the sensor unit 408. In the embodiment 400 of FIG. 4 by means of differentially driving the two lift bodies 402 with the two separate drive units 406 omnidirectional propulsion can be achieved by means of which the robot 400 in the same manner as the first to third embodiments already described can travel along the ceiling D.

What is claimed is:

1. A robot, which is adapted for movement underneath and in contact with a ceiling, the robot comprising:
at least one lift body, which is filled with gas which is lighter that air; and
at least one drive unit, which is configured to drive the at least one lift body in rotation or rolling on the ceiling;
wherein the unit is positioned with respect to the lift body in such a manner that, during movement of the robot, the robot remains spaced apart from the ceiling.

2. The robot according to claim 1, further comprising at least one sensor unit.

3. The robot according to claim 2, wherein the at least one sensor unit is provided together with the at least one drive unit on a common carrier unit.

4. The robot according to claim 1, wherein the at least one lift body comprises a single substantially spherical lift body.

5. The robot according to claim 1, wherein the at least one lift body has a cylindrical shape.

6. The robot according to claim 5, wherein the at least one lift body comprises a plurality of cylindrical lift bodies, which are coupled by means of an external structural element.

7. The robot according to claim 6, wherein the external structural element comprises the at least one drive unit.

8. The robot according to claim 1, further comprising at least one sensor unit, wherein the at least one lift body comprises a single lift body, and the at least one drive unit and the sensor unit are fully housed inside the single lift body.

9. The robot according to claim 8, wherein the at least one drive unit and the sensor unit are fully housed inside the single lift body in a manner not fixedly connected to the single lift body.

10. The robot according to claim 1, wherein the at least one lift body comprises a single lift body, and the at least one drive unit is arranged outside the single lift body.

11. The robot according to claim 10, wherein the at least one drive unit is held in contact with the single lift body by means of magnets arranged inside the single lift body.

12. The robot according to claim 1, wherein the at least one drive unit comprises an omnidirectional drive element.

13. The robot according to claim 12, wherein the omnidirectional drive element comprises two or more drive wheels or a spherical drive element in contact with the lift body.

14. The robot according to claim 1, wherein the lift body is made from transparent and/or deformable material.

15. The robot according to claim 1, wherein the at least one lift body is surrounded by a further mantle body which is of substantially the same shape yet larger dimensions than the lift body.

16. The robot according to claim 15, wherein the further mantle body is made from transparent and/or deformable material.

17. The robot according to claim 1, further comprising an energy storage unit for powering components of the robot.

18. The robot according to claim 17, wherein the energy storage unit is capable of being charged in a contactless manner via induction.

19. The robot according to claim 1, further comprising a jump mechanism which is configured to cause a push-off of the lift body from the ceiling upon operation.

20. The robot according to claim 1, further comprising a control unit which is configured to operate the robot in an autonomous mode.
